(19) United States
(12) Patent Application Publication
(10) Pub. No.: US 2012/0174987 A1
(43) Pub. Date: Jul. 12, 2012

(54) Flameless heating system

(76) Inventors: James B. Crawford, Lafayette, LA (US); Rusty Lamb, Broussard, LA (US); John Bibaeff, Lafayette, LA (US)

(21) Appl. No.: 13/199,465

(22) Filed: Aug. 31, 2011

Related U.S. Application Data
(60) Provisional application No. 61/378,627, filed on Aug. 31, 2010.

(51) Int. Cl. B08B 9/00; F28B 1/00

(52) U.S. Cl. 137/15.04; 165/110

(57) ABSTRACT

A method of cleaning a pipeline that may include the steps of pumping a process fluid through a flameless heating unit, preheating the process fluid before it enters a dynamic heat generator, controlling the flameless heating unit to heat the process fluid to a temperature in a range sufficient to melt deposits disposed in the pipeline, and transferring the process fluid from the flameless heating unit into the pipeline. Other steps may include using the heated process fluid to operate a tool operatively disposed in the pipeline, whereby the heated process fluid and the tool work collectively to melt and clear the deposits. The flameless heating unit may include an internal combustion engine, a dynamic heat generator operatively connected to the internal combustion engine, and a pump configured to provide a discharged fluid to the dynamic heat generator.

### CROSS-REFERENCE TO RELATED APPLICATIONS

This application claims priority to U.S. Provisional Patent Application Ser. No. 61/378,627, filed on Aug. 31, 2010.

### BACKGROUND OF DISCLOSURE

1. Field of the Disclosure

Embodiments disclosed herein generally relate to the transferring, heating, and pumping of fluids. Specific embodiments are directed to a flameless heating system and process. Other embodiments pertain to a modular skid-mounted unit capable of pumping, heating, and transferring fluids, which includes a dynamic heat generator driven by a motor.

2. Background Art

A characteristic common to hydrocarbon production operations throughout the world is the eventual build-up of a wax or paraffin component of the hydrocarbons that deposits on the walls of a pipeline, and solidifies at low temperatures. Some of these waxes or paraffins deposit and/or solidify at temperatures in excess of 100 degrees Fahrenheit, which means the deposits will form on pipeline surfaces even at temperatures close to ambient temperature. Once deposits form, the thickness of the deposit layer will increase over time, which causes, for example, increased pressure drop and/or decrease in desired flow rate in the pipeline.

Several known methods intended to deal with the negative effects of deposit build up include the use of chemicals and hot water injection, which subsequently return the deposits back into solution. However, prior art methods are limited in what they provide. For example, the use of chemicals requires a chemical storage facility, as well the ability to inject the chemicals into the system at high pressures. The use of chemicals is cost-prohibitive not only because of the large capital and equipment costs, but also the continual operating costs associated with the maintenance and handling of hazardous chemicals. It is further necessary for expensive separation processes in order to subsequently remove the chemicals from any produced hydrocarbons, such that the use of chemicals is not practicable.

In order to use heated fluids, it is generally necessary to have a heating source with an open flame, such as a gas fired heater, a furnace, etc. However, gas fired sources and the like suffer from high maintenance, noise pollution, short life spans, disproportionate fuel consumption, and fire hazards. Even more problematic is that there are many instances today where the use of an open flame is not desirous or is prohibited, such as in the oilfield industry. Thus, some prior art methods are directed to flameless systems in order to overcome the deficiencies, such as the use of steam generation.

In order to create steam, it is necessary to build a generation plant, typically designed to use production gases, and eventually inject steam into a producing formation. While there may not be an open flame in the vicinity of the producing formation, a flame may still be used, such as to ignite and burn the gases. In addition, there are large capital costs associated with building the plant, such that steam generation is only viable when there is an overabundance of gases available for burning. Because of the logistics and/or distances, there is often pressure drop associated with line losses that results in condensation. Condensed steam requires injection of liquid instead of vapor, thereby raising injection costs, and also results in a loss of heat.

Alternatively, some fluids are heated with systems that include electrical devices. However, the use of these devices is even more problematic because electrical devices are prone to arcing and/or sparking that result in destructive blasts or ignition of flammable vapors.

Accordingly, there exists a need for a modularized single-unit skid configured for on-site location to provide a flameless heating source that does not require an open flame, chemicals, or electrical devices. There also exists a need for a flameless heating system that may supply high-pressure heated fluids directly into pipelines. Other needs require a self-contained modularized unit that may provide heated fluids without the use of a flame so that the unit may be used in remote or otherwise hazardous oil and gas environments.

### SUMMARY OF DISCLOSURE

Embodiments disclosed herein may provide for methods of cleaning pipelines that may include the steps of pumping a process fluid through a flameless heating unit, preheating the process fluid before it enters a dynamic heat generator, controlling the flameless heating unit to heat the process fluid to a temperature in a range sufficient to melt deposits disposed in the pipeline, and transferring the process fluid from the flameless heating unit into the pipeline. Other steps may include using the heated process fluid to operate a tool operatively disposed in the pipeline, whereby the heated process fluid and the tool work collectively to melt and clear the deposits. The flameless heating unit may include an internal combustion engine, the dynamic heat generator operatively connected to the internal combustion engine, and a pump configured to provide a discharged fluid to the dynamic heat generator.

Other embodiments disclosed herein may provide a single skid modular flameless heating unit that may include an internal combustion engine, a dynamic heat generator operatively connected to the internal combustion engine, a pump being responsive to the operation of the internal combustion engine, a first heater configured to cross exchange heat produced by a combustion cycle of the internal combustion engine with the discharged fluid before the discharged fluid enters the dynamic heat generator. There may be a second heater configured to cross exchange heat produced by the combustion cycle of the internal combustion engine with a heated fluid stream produced by the dynamic heat generator, such that a process outlet from the second heat is transferred into a pipeline in order to melt paraffins disposed in the pipeline.

Additional embodiments disclosed herein may provide a flameless heating process usable for treating fouled pipelines. The process may include the steps of receiving a process fluid into a modular flameless heating unit. The flameless heating unit may include an internal combustion engine, a dynamic heat generator operatively connected to the internal combustion engine, a pump configured to provide a discharged fluid to the dynamic heat generator, and a first heater configured to cross exchange radiated heat produced by a combustion cycle of the internal combustion engine with the discharged fluid before the discharged fluid enters the dynamic heat generator. Further steps of the process may include preheating the process fluid with the modular flameless heating unit, further heating the process fluid with the operation of the dynamic heat generator to a predetermined temperature, outletting the process fluid from the single skid flameless heating unit to a desired location, and using a second heater configured to cross exchange vapor heat produced by the combustion cycle of the internal combustion engine with a heated fluid stream produced by the dynamic heat generator.

Other aspects and advantages of the disclosure will be apparent from the following description and the appended claims.

### BRIEF DESCRIPTION OF DRAWINGS

FIG. 1A shows process flow diagram of a flameless heating system, in accordance with embodiments of the present disclosure.

FIG. 1B shows a close-up isometric view of interconnectivity between an output shaft and a dynamic heat generator useable in the flameless heating system of FIG. 1A, in accordance with embodiments of the present disclosure.

FIG. 2A shows a process flow diagram of a flameless heating system, in accordance with embodiments of the present disclosure.

FIG. 2B shows a process flow diagram of an alternate flameless heating system, in accordance with embodiments of the present disclosure.

FIGS. 2C and 2D show a close-up isometric view of interconnectivity between an output shaft and a dynamic heat generator, and a side perspective view of the dynamic heat generator, respectively, usable in the flameless heating systems of FIGS. 2A and 2B, in accordance with embodiments of the present disclosure.

FIG. 3 shows a process flow diagram of a high efficiency flameless heating system, in accordance with embodiments of the present disclosure.

FIG. 4 shows a process flow diagram of a flameless heating system configured with a process control scheme, in accordance with embodiments of the present disclosure.

FIGS. 5A, 5B, 5C, 5D, and 5E show an isometric view and multiple side views, respectively, of a modular flameless heating unit, in accordance with embodiments of the present disclosure.

### DETAILED DESCRIPTION

Specific embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the disclosure. However, it will be apparent to one of ordinary skill in the art that the embodiments disclosed herein may be practiced without these specific details. In other instances, well-known features have not been described in detail to avoid unnecessarily complicating the description.

In addition, directional terms, such as “above,” “below,” “upper,” “lower,” “front,” “back,” etc., are used for convenience in referring to the accompanying drawings. In general, “above,” “upper,” “upward,” and similar terms refer to a direction toward the earth's surface from below the surface along a wellbore, and “below,” “lower,” “downward,” and similar terms refer to a direction away from the surface along the wellbore (i.e., into the wellbore), but is meant for illustrative purposes only, and the terms are not meant to limit the disclosure.

Embodiments disclosed herein may provide an apparatus, system, and process for the transferring, heating, and pumping of fluids. In an embodiment, a flameless heating apparatus may include a single skid-mounted unit. As such, the flameless heating apparatus may be a single unit that permits the transfer, heating, pumping of fluids. Further, the apparatus may be a highly efficient modular unit configured to heat and transfer process fluid, which may include without limitation, oil, diesel, water, or combinations thereof.

There are a number of applications whereby embodiments of the present disclosure may be beneficially used. For example, in the aid of removal of stuck pigs from pipelines where the pig becomes stuck as a result of paraffin buildup or hydrate plugs. Other applications include washing out paraffin from subsea pipelines or cleaning deepwater umbilical chords. In addition, embodiments may be used for the treatment of heavy crude or other process fluids before pumping the fluids through transfer lines, as well as cleaning oil storage vessels when paraffin builds up on bottom of holding tanks.

By way of example, the following applications are discussed below.

Pipeline Cleanouts

The modular unit may be used to feed high pressure, heated fluids to dissolve wax plugs, hydrates, asphaltenes, etc., which may have accumulated or otherwise deposited within the pipeline. Conventional methods to clean pipelines with coiled tubing use expensive chemical compositions to dissolve plugs and other obstructions. Use of embodiments disclosed herein advantageously reduce or eliminate chemical costs by delivering hot oil, hot diesel, or other heated fluids in place of such expensive chemicals.

Flowline Cleanouts with Wire Wash Tool

In some embodiments, systems and methods disclosed herein may be used with a free running pig for improved cleaning of pipelines (e.g., flow lines, transfer lines, etc.). For example, the system may include the provision of heated fluids to high-pressure pump inlets, as well as the use of braided line through flow lines with a wire wash tool or other similar equipment. The method and apparatus of the present invention provides the ability to run braided line horizontally, and clean out partially plugged flow lines or pipelines by use of the tool or pig in conjunction with flamelessly heated fluids. As such, production may be dramatically increased by the removal of obstructions and the increase of flow area within the pipelines. Beneficially, embodiments disclosed herein may remove such obstructions without the need to use or pump in large amounts of expensive chemicals.

Circulating Risers

Other embodiments may include the use of flameless heated fluids within a riser. For example, during maintenance and other down periods on deep-water oil & gas wells, risers sometimes plug up or become obstructed without flow. Such risers may be very expensive to unplug or clean. Currently, expensive electric heating devices are used to heat such risers during prolonged periods with no flow. However, systems and methods of the present disclosure may be used to circulate heated fluids within a riser until maintenance is completed or flow can be re-established in such riser, and whereby there is no electrical requirement.

Heating Frac Fluids

Currently, direct fire hot oil units heat fracing fluid in enclosed tank(s) until sufficiently hot, and then such fluids are placed in large tanks prior to injection down hole. Embodiments disclosed herein may be used to heat fracing fluids, including fluids maintained in multiple tanks, until such fracing fluids reach desired temperature, thereby saving rig time and speeding up fracing operations.

Heavy Crude Treatments

In certain areas around the world crude oil viscosity makes such crude too thick to flow. Embodiments disclosed herein may be used to heat such crude, and potentially add thinning solutions, until light enough to pump down lines.

Oil Tankers

When oil in oil tankers cool, the bottoms of such tankers may have several layers of wax or other materials deposited on the bottom of such tankers. Conventional methods involve cutting hole(s) in the holding tanks and shoveling out such wax and/or other deposits, and sometimes scraping same with heavy machinery. Advantageously, embodiments disclosed herein may be used to circulate heated fluids within or in association with the oil until the wax melts, whereby the melted wax and/or other liquids may be pumped out of a tanker.

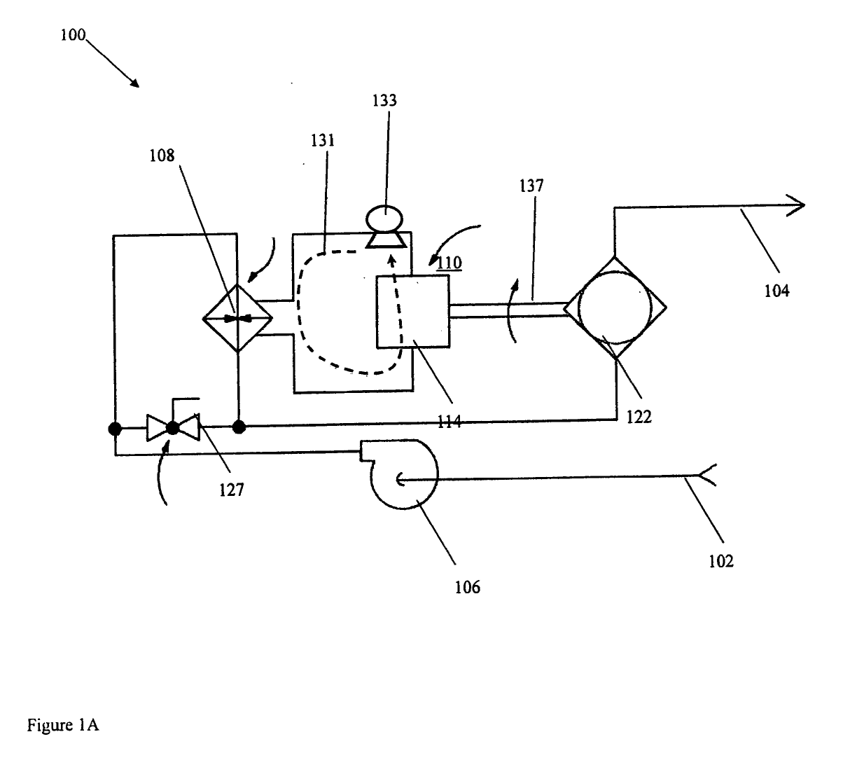

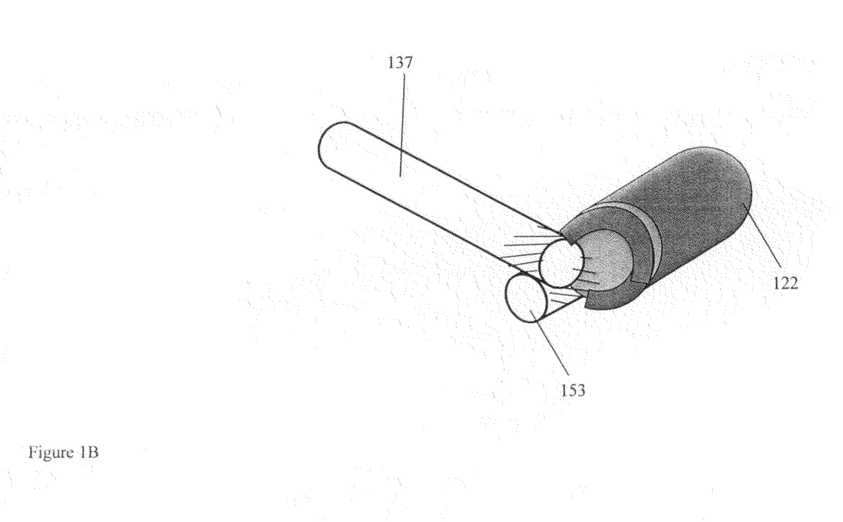

Referring now to FIG. 1A, a process flow diagram of a flameless heating system 100 according to embodiments of the present disclosure, is shown. The flameless heating system 100 may include a number of components configured together for the heating and transferring of fluids therethrough. The system 100 may include an inlet flow line 102 coupled to an inlet pump 106. The pump 106 may be sized and configured accordingly to provide sufficient motive and driver for fluid discharged from the pump 106, whereby the fluid may adequately and/or completely flow from the system inlet 102 to a system outlet 104, and the head of the fluid may be sufficient to overcome any losses incurred from the system 100.

One or more heat exchangers or heaters 108 may be connected with the pump 106, as well as with a dynamic heat generator (DHG) 122. Accordingly, process fluids may be pre-heated by heater 108 before the fluids enter into the DHG 122. In an embodiment, process fluids may enter into the heater 108 and may subsequently be heated by way of cross exchange with heat provided by an engine 110. As such, the heater 108 may be connected between the pump 106 and the DHG 122 whereby heat may be transferred from the engine 110 to the process fluids before the fluids are further heated by the DHG 122.

The engine 110 may be, for example, a diesel engine, an internal combustion engine, a turbine, a hydraulic motor, etc., and may include a motor 114 operatively connected therewith, as would be known to one of ordinary skill in the art. In an embodiment, the power used to power the system 100 may be from the operation of the engine 110. By way of example, engine 110 may be a seventy-five horsepower diesel engine operatively configured for use in the system 100. FIG. 1A illustrates the coupling between an output shaft 137 of the motor 114 and the DHG 122, such that rotational energy of the motor 114 may be transferred, mechanically or otherwise, to the DHG 122. Although not shown, the engine 110 may be configured to provide additional rotary motion to a plurality of pumps coupled with the engine 110.

Thus, system 100 may include the engine 114 used to drive and/or rotate the DHG 122 and/or any subcomponents associated therewith. Accordingly and advantageously, the DHG 122 may be driven by engine motor 114 in order to heat the fluids to a predetermined temperature without the need for a flame. The change in temperature between process fluids that enter and then exit the DHG 122 and may be controlled, for example, by variation of process flow rates, modifications of the DHG 122 surface area, etc., as would be apparent to those of ordinary skill in the art.

Referring now FIG. 1B, a close-up isometric view of interconnectivity between an output shaft 137 and a DHG 122 according to embodiments disclosed herein, is shown. FIG. 1B shows an example of an operative interconnectivity relationship between the shaft 137 and the DHG 122. As previously mentioned the DHG 122 may include various components or subcomponents associated therewith, such as one or more rotatable internal members 153. In some embodiments, the DHG 122 may be operatively connected with an output shaft 137 of the motor 114, while in other specific embodiments one or more members 153 may be operatively connected with the output shaft 137. As such, the DHG 122 may be configured for the output of the motor 114 to rotate the member 153, whereby rotational energy is mechanically transferred from the motor 114 to the DHG 122.

Running the motor 114, and hence shaft 137 at a designated speed, such as in the range of 3000 RPMs, may cause the member 153 to rotate, whereby various structures, such as vanes or other protrusions (not shown) disposed on the member 153 may also rotate. The rotational motion of the member 153 may cause compression of molecules associated with the process fluid that flows within the DHG 122, which subsequently may generate friction and heat that transfers to the fluid and raises the temperature of the fluid.

In some embodiments, the resultant temperature of the heated process fluid that exits the DHG 122 may be in the range of 200-300 degrees Fahrenheit. In other embodiments, the resultant temperature of the heated fluid may be in the range of 300-500. In a particular embodiment, the resultant temperature of the heated fluid may be in the range of temperature(s) required to melt paraffins formed on inner surfaces of pipelines.

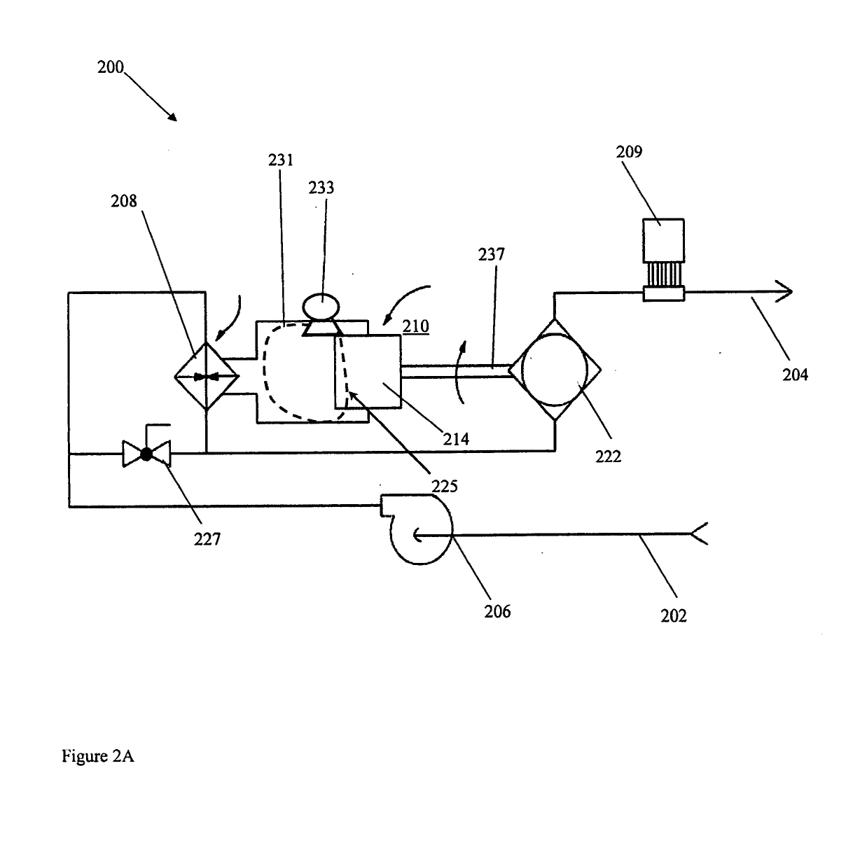

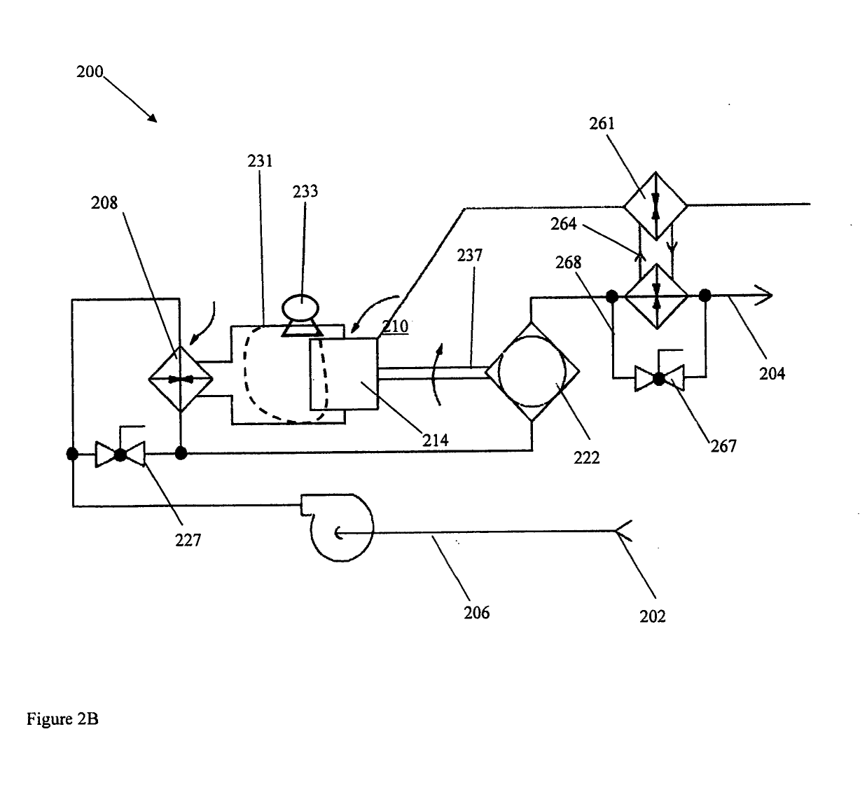

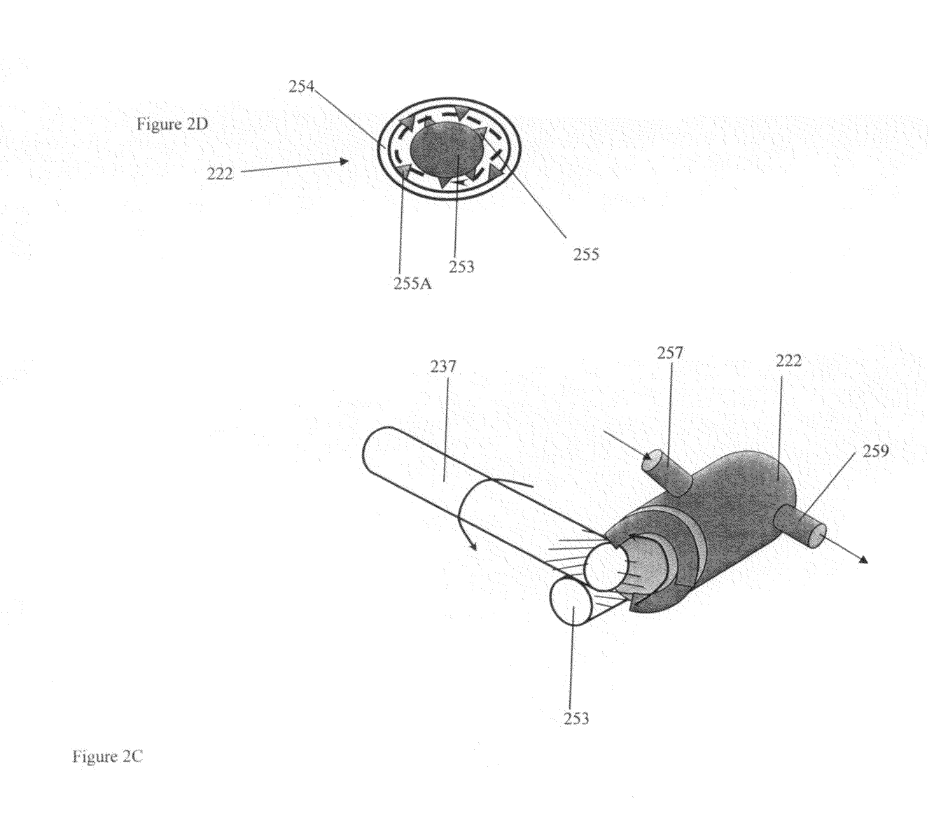

Referring now to FIG. 2A, a process flow diagram of a flameless heating system 200 according to embodiments of the present disclosure, is shown. Like the system 100 previously described, the flameless heating system 200 may be a modularized system used to pump, transfer, and heat fluids without the use of an open flame. The system 200 may include similar components, unit operations, and materials of construction as described for system 100, however, the systems need not necessarily be identical.

As shown, the system 200 may include an inlet flow line 202 coupled to an inlet pump 206. Pump 206 may be sized and configured accordingly to provide sufficient motive and driver for fluid to flow through the system 200 between the inlet 202 and a system outlet 204, such that the head of the fluid is sufficient to overcome any losses incurred as a result of the transfer of the fluid through the system 200.

The inlet pump 206 may be, for example, a low-pressure pump. In operation, pump 206 may be configured to function within operational parameters such as 5,000-12,000 gpm, approximately 500-600 horsepower, and may produce a pressurized discharge flow in a range of about 4 bars. In other embodiments, the flow rate may be in the range of 15,000-25,000 gpm.

As a result of frictional losses, velocity head, etc., the pressure of the process fluid transferred through the system 200 may be reduced. As such, a booster pump 209 may be used to boost the pressure, such that the system 200 may thus include the booster pump 209 coupled with the system outlet 204. In some embodiments, the booster pump 209 may be a high-pressure pump. As is known to those of ordinary skill in the art, high-pressure pumps may be operated at lower pressures, and as such, the booster pump 209 may be operated accordingly in order to transport heated fluids out of the system 200. Advantageously, booster pump 209 may be able to deliver high pressure pumping when needed, as well as a low pressure pumping as appropriate. In this way, optimum pumping may be available at all times during operation of the system 200. A high-pressure pump(s) suitable for use with system 200 are commercially available.

In operations when high pressure pumping is used or desired, the normal operating pressure provided by the booster pump 209 may be a fluid pressure of at least 10 bars. In some embodiments, the booster pump 209 may be used to boost the pressure to a pressure range of about 100-200 bars. At other times during operation when high pressure is unnecessary, the booster pump 209 may be configured or operated to provide a fluid pressure in the range of about 1 to 5 bars.

While a single high pressure pump may be quite sufficient to transport the heated process fluids through pipelines, transfer lines, etc., one or more auxiliary pumps (not shown) may also be provided in the pipeline so as to extend the distance pumped or to further increase the pressure.

One or more heaters 208 may be connected with the inlet pump 206, as well as with a dynamic heat generator (DHG) 222. For example, the heater 208 may receive an inlet flow from the pump 206, whereby the flow may be heated within the heater 208, exit the heater 208, and flow into the DHG 222. Accordingly, process fluids discharged from the pump 206 may be pre-heated by heater 208 before the fluids enter into the DHG 222. Alternatively, the discharged fluids may bypass heater 208 by way of bypass valve 227. The bypass valve 227 may be, for example, a conventional block valve, three-way valve, etc.

In an embodiment, fluids entering the heater 208 may be heated by way of cross exchange with heat provided by an engine 210. As is the case in other embodiments, the use of preheating may increase the overall efficiency of the system and take advantage of otherwise wasted energy. In some embodiments, the heater 208 may be associated with the recirculation or cooling loop of the engine 210. FIG. 2 illustrates a circulation flow path 231 whereby a recirculation fluid may loop between the engine 210 and the heater 208. A first recirc pump 233 may be used to provide sufficient motive force to continuously loop the recirculation fluid.

As would be known to one of skill in the art, the engine 210 may be configured with an internal flow path or configuration 225 for the recirculation fluid to pass therethrough. As a result of the flow loop, heat radiated by or from the engine 210 may be transferred to the recirculation fluid resulting in an increased temperature of the fluid as it leaves the engine 210, and a corresponding cooling of the engine 210. The recirc pump 233 may be used to urge the fluid through the heater 208, whereby the recirc fluid may transfer the heat to the process fluid.

The engine 210 may be, for example, a diesel engine, an internal combustion engine, a turbine, a hydraulic motor, etc. By way of illustration, the engine 210 may be a one hundred horsepower diesel engine. In an embodiment, the power source for the system 200 may be the engine 210, which may also further include a motor 214 operatively connected therewith. As shown, the motor 214 may further include an operative connection with an output rotational shaft 237 that may be also coupled with the DHG 222.

Referring now to FIGS. 2C and 2D, a close-up isometric view of interconnectivity between an output shaft 237 and a DHG 222, and a side perspective view of the DHG 222, respectively, according to embodiments disclosed herein, are shown. FIG. 2C illustrates an example of an operative interconnectivity relationship between the shaft 237 and the DHG 222. Although not meant to be limited, the operative connection between the shaft 237 and the DHG 222 may be by mechanical linkage, such as mesh gears, worm gears, etc.

The DHG 222 may include various components, such as one or more rotatable internal members 253. Running the motor 214, and hence shaft 237 at a designated speed, such as in the range of 5000 RPMs, may cause the member 253 to rotate, whereby various structures or protrusions 255 disposed on the member 253 may also rotate. The rotational motion of the member 253 may cause compression of molecules associated with the process fluid, which subsequently may generate friction and heat that transfers to the fluid and raises the temperature of the fluid.

FIG. 2D illustrates an example of where the DHG 222 may include the member 253 with protrusions 255 associated with a fixed body 254 that may include corresponding protrusions 255A. In operation, fluid may enter the DHG 222 at inlet 257. As the member 253 rotates, fluid in contact with the protrusions 255, 255A may be subjected to outer and/or centrifugal forces. In addition, the fluid within the DHG 222 may incur a pressure increase that results in continuous motion of the fluid along the protrusions 255, 255A that may consequently cause additional kinetic energy or heat within the fluid.

Referring again to FIG. 2A, the heated fluid may exit from the DHG 222 via an outlet (259, FIG. 2C), and the fluid may exit the system 200 by transfer with the pump 209. The flow of fluid that exits the system 200 may be controlled via a process control system (not shown), as would be known to one of ordinary skill in the art. In some embodiments, by controlling the process fluid flow and the power provided to the DHG 222, the process fluid that flows through the system 200 may be heated to any suitable temperature, as desired.

Referring now to FIG. 2B, a process flow diagram of an alternate flameless heating system 200A according to embodiments of the present disclosure, is shown. Like system 200, the system 200A may be a modularized system used to pump, transfer, and heat fluids without the use of an open flame. The system 200A may include similar components, unit operations, and materials of construction as described for system 200, however, the systems are not necessarily identical.

In some aspects, system 200A may be a “green” system that reduces carbon emissions, reduces carbon imprint, and operates with high efficiency. As shown, the system 200A may include an inlet flow line 202 coupled with a system inlet pump 206. There may be one or more heaters 208 connected with the pump 206, as well as with a dynamic heat generator (DHG) 222. Accordingly, fluids may be pre-heated by exchanger 208 before the fluids inter the DHG 222. In an embodiment, the heater 208 may be configured to cross exchange heat produced by an engine 210 with the process fluid. Alternatively, the discharged fluids may bypass heater 208 by way of bypass valve 227.

The engine 210 may include a motor 214, as well as an operative connection between an output shaft 237 of the motor 214 and the DHG 222, whereby rotational energy of the motor 214 may be transferred to the DHG 222. Thus, system 200 may include the engine 210 configured to drive the DHG 222 and/or rotate internal components thereof. The DHG 222 may heat the fluids to any suitable amount (specified temperature). The delta temperature may be controlled, for example, by modification of the flow rates, changes in DHG surface area, etc., as would be apparent to one of ordinary skill in the art.

As FIG. 2B shows, the system 200A may beneficially include the use of a secondary heater 261, which may be used to capture and utilize additional waste energy, such as hot vapors that result from combustion within the engine 210. Thus, the hot vapors may flow from the combustion chamber (not shown) to the inlet of the heater 261, whereby the heat of the vapor may be exchanged with a utility fluid 264 that loops between the secondary heater 261 and an outlet heater 262.

The use of the secondary heater 261 may be extremely beneficial when the utility fluid 264 may be heated to a temperature range that is greater than an exit temperature of the heated fluids that enter into the outlet heater 262 from the DHG 222. If the temperature of the utility fluid 264 is lower than the heated process fluid that exits the DHG, the process fluids may bypass the outlet heater 262 by way of bypass line 268. In an embodiment, the bypass flow may be controlled or adjusted by way of bypass valve 267.

Any of the heaters described by embodiments disclosed herein, may be conventional heaters, such as shell and tube, plate and frame, spiral, etc., as would be known to one of ordinary skill in the art for use in the transfer of heat between one or more mediums and/or fluids.

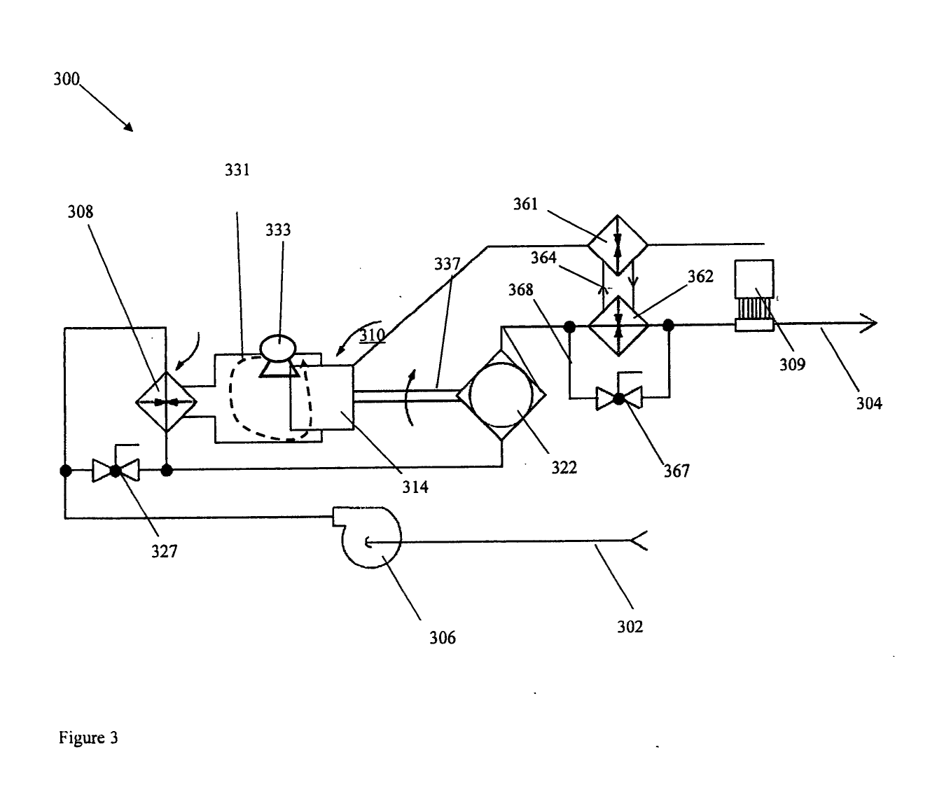

Referring now to FIG. 3, a process flow diagram of a high efficiency flameless heating system 300 according to embodiments of the present disclosure, is shown. Like the systems previously described, the flameless heating system 300 may be a modularized system used to pump, transfer, and heat fluids without the use of an open flame. The system 300 may include similar components, unit operations, and materials of construction as described for systems 100, 200, etc., however, the systems are not necessarily identical.

As shown, the system 300 may include an inlet flow line 302 coupled with a system inlet pump 306. The pump 306 may be sized and configured accordingly to provide sufficient motive and driver for fluid to flow between the system inlet 302 and a system outlet 304, such that the head of the fluid is sufficient to overcome any losses incurred from the system 300.

One or more heaters 308 may be connected with the pump 306, as well as with a dynamic heat generator (DHG) 322. Accordingly, fluids may be pre-heated by heater 308 before the fluids enter into the DHG 322. In an embodiment, the heater 308 may be configured to cross exchange heat produced by an engine 310 with the process fluid. Alternatively, the discharged fluids may bypass heater 308 by way of bypass valve 327.

The engine 310, which may be, for example, a diesel engine, an internal combustion engine, a turbine, a hydraulic motor, etc., may include a motor 314. FIG. 3 illustrates an operative connection between an output shaft 337 of the motor 314 and the DHG 322, whereby rotational energy of the motor 314 may be transferred to the DHG 322. Thus, system 300 may include the engine 310 used to drive the DHG 322 and/or rotate internal components thereof. The DHG 322 may heat the fluids to any suitable amount (specified temperature). The delta temperature may be controlled, for example, by modification of the flow rates, changes in DHG surface area, etc.

As FIG. 3 shows, the system 300 may beneficially include the use of a secondary heater 361, which may be used to capture and utilize additional waste energy, such as hot vapors that result from combustion within the engine 310. Thus, the hot vapors may flow from a combustion chamber (not shown) to the inlet of the heater 361, whereby the heat of the vapor may be exchanged with a utility fluid 364 that loops between the secondary heater 361 and an outlet heater 362. If the temperature of the utility fluid 364 is lower than the heated process fluid that exits the DHG 322, the process fluids may bypass the outlet heater 362 by way of bypass line 368. In an embodiment, the bypass flow may be controlled or adjusted by way of a bypass valve 367.

Any of the heaters described by embodiments disclosed herein, may be conventional heaters, such as shell and tube, plate and frame, spiral, etc., as would be known to one of ordinary skill in the art for use in the transfer of heat between one or more mediums and/or fluids.

As a result of frictional losses, velocity head, etc., the pressure of the process fluid transferred through the system 300 may be reduced. As such, a booster pump 309 may be used to boost the pressure, such that the system 300 may thus include the booster pump 309 coupled with the system outlet 304. In some embodiments, the booster pump 209 may be a high-pressure pump.

In operations when high pressure pumping is used or desired, the normal operating pressure provided by the booster pump 309 may be a fluid pressure of at least 10 bars. In some embodiments, the booster pump 309 may be used to boost the pressure to a pressure range of about 100-200 bars. At other times during operation when high pressure is unnecessary, the booster pump 309 may be configured or operated to provide a fluid pressure in the range of about 1 to 5 bars.

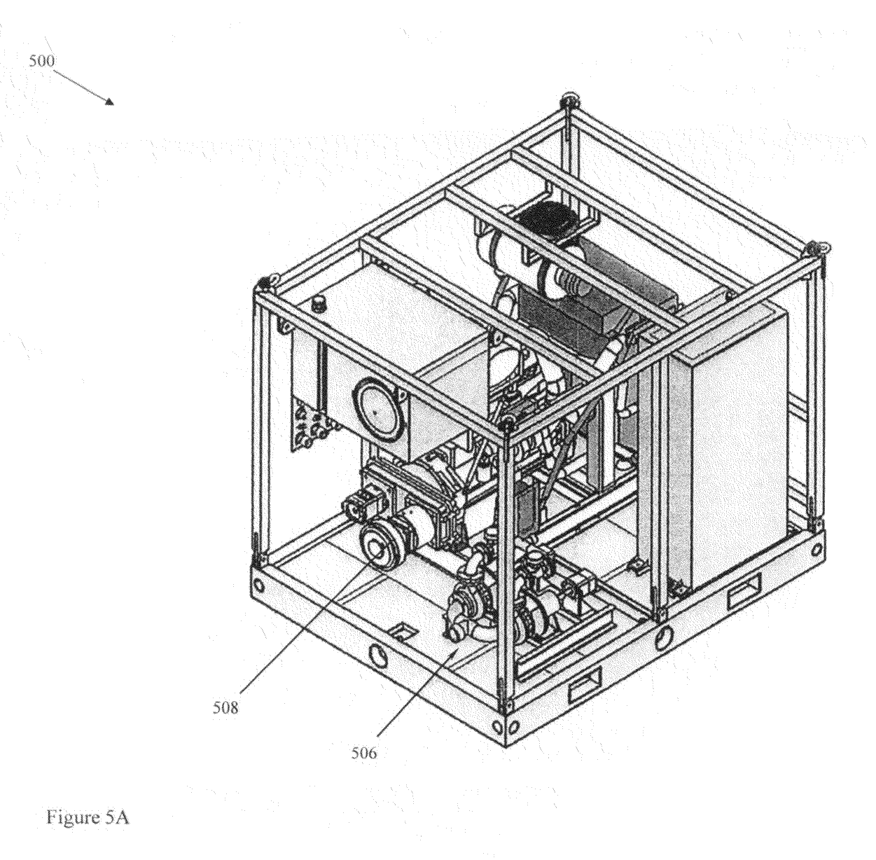

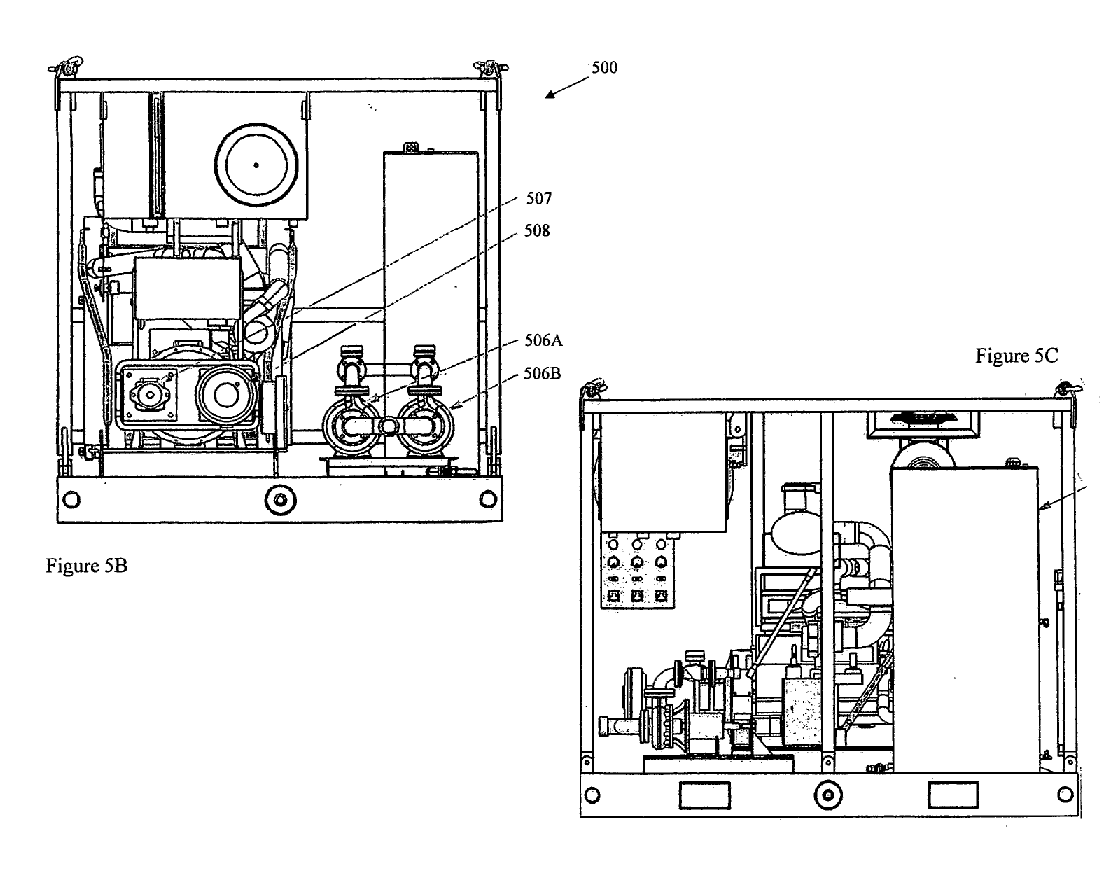

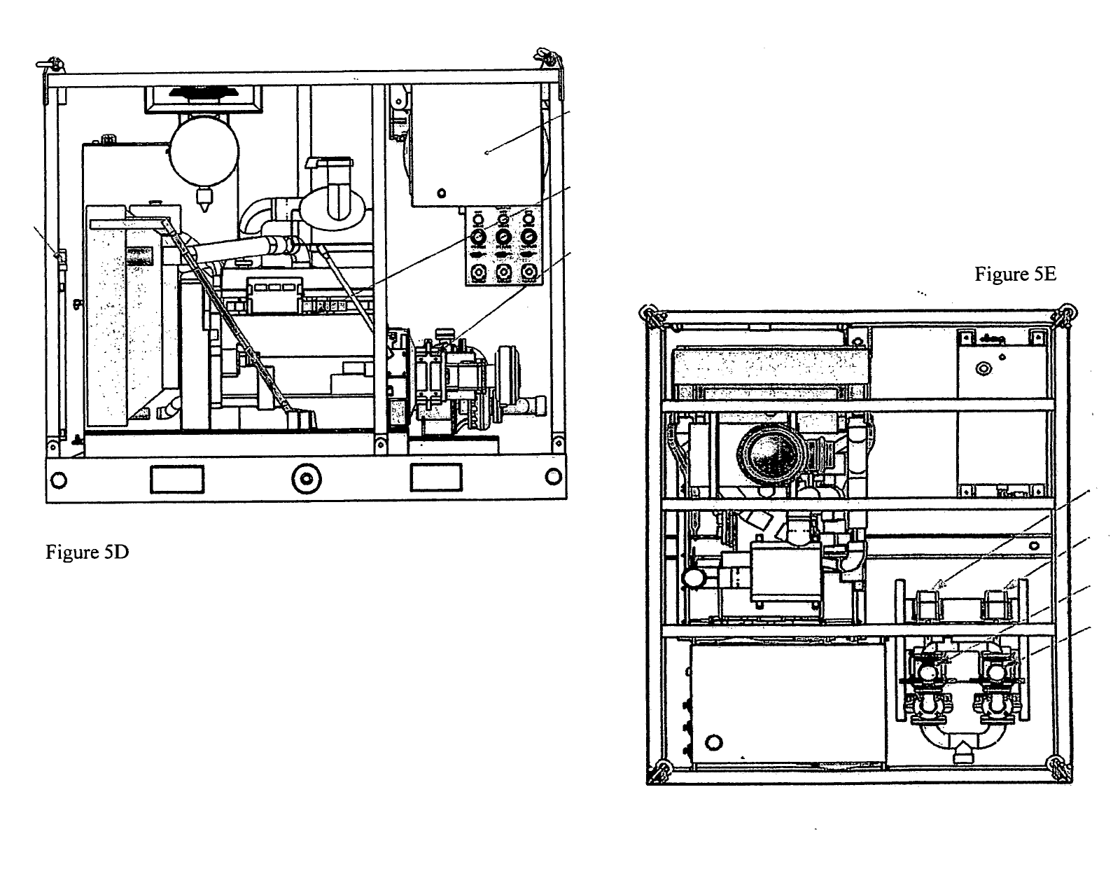

Referring now to FIGS. 5A-5E, an isometric view and multiple sideway perspective views, respectively, of a modularized flameless heating unit 500 in accordance with embodiments disclosed herein, are shown. Beneficially, components and subcomponents of flameless heating systems previously described may be configured with new and useful embodiments disclosed herein that provide a portable, modularized unit 500. As such, the unit 500 may include similar components, unit operations, and materials of construction as previously described for system 100, 200, 300, and 400; however, they are not necessarily identical.

In operation, a process fluid may be pumped or otherwise transferred into the modular unit 500, whereby the temperature of the fluid may be raised as a result of hydrodynamic action imparted thereon. The modular unit 500 may include a frame 501, and a dynamic heat generator (DHG) 522 disposed within the frame 501. The DHG 522 may be operatively engaged with an assembly that may include an engine 510 and motor 514, whereby the engine 510 and the motor 514 are also disposed within the frame 501. The motor 514 may be used to operate the DHG 522 in order to heat the temperature of a fluid to a predetermined temperature without the necessity of a flame while doing so.

The difference in temperature between the process fluid that enters the DHG 522 and the subsequently heated process fluid that exits the DHG 522 may be controlled, for example, by adjusting process flow rates. Thus, at one point in the sequence of the operation of unit 500 the exit temperature may be about 400 degrees Fahrenheit. If the flow rate of the process fluid is increased, the temperature of the exit fluid may as a consequence be reduced.

Although not limited by any scale depicted or described, in some embodiments, the DHG 522 may be approximately two feet in diameter and one foot in width. In some embodiments, the DHG 522 and any of its associated components may be made from a durable material, such as steel or aluminum. However, the materials of construction are not meant to be limited, and hence the DHG 522 may just as well be constructed from other materials in other embodiments.

In particular embodiments, the dynamic heat generator may be similar or identical to an Island City, LLC dynamic heat generator. In operation, the motor 514 may run in a range of 1500-4500 RPMs. As previously explained, the rotational energy from the motor 514 may be converted into heat and energy that is transferred to the process fluid by way of the DHG 522. The operation of the engine 510 may result in various waste or product streams that may have heat utility associated therewith. Thus, any resultant heat from operation of the engine 510 may be advantageously used to improve the efficiency of the unit 500. For example, a heating loop may be used to capture other waste heat streams in order to add efficiency to the system.

The DHG 522 essentially acts as a device that uses the rotational energy generated by the motor 514, whereby process fluid that flows through the DHG 522 may include a relatively low velocity near its center and a high velocity at its outer diameter such that kinetic energy (heat) may be created or caused in the fluid. The result is the fluid flowing at a maximum velocity and the creation of kinetic energy (heat).

The ability of the DHG to utilize power created by the engine 510 may be understood with an understanding of basic principles of engineering, such as pump power laws. For example, power capacity is proportional to the input speed to the third power, and power capacity is proportional to the rotors diameter to the fifth power.

The modular unit 500 may be completely self-contained, and may be further sized and configured for quick installation. While installation of the unit 500 may be permanent, the single skid unit 500 may just as well be portable, including a quick-connect coupling system.

The modular unit 500 may include at least one heater 508, the engine 510, the motor 514, and a pump 506. In an embodiment, the pump 506 may be connected to a drive shaft (not shown) associated with the engine 510. The pump 506 may be coupled with a fluid inlet 502, and the fluid inlet 502 may be further associated or connected with a fluid source (not shown) located external of the unit 500.

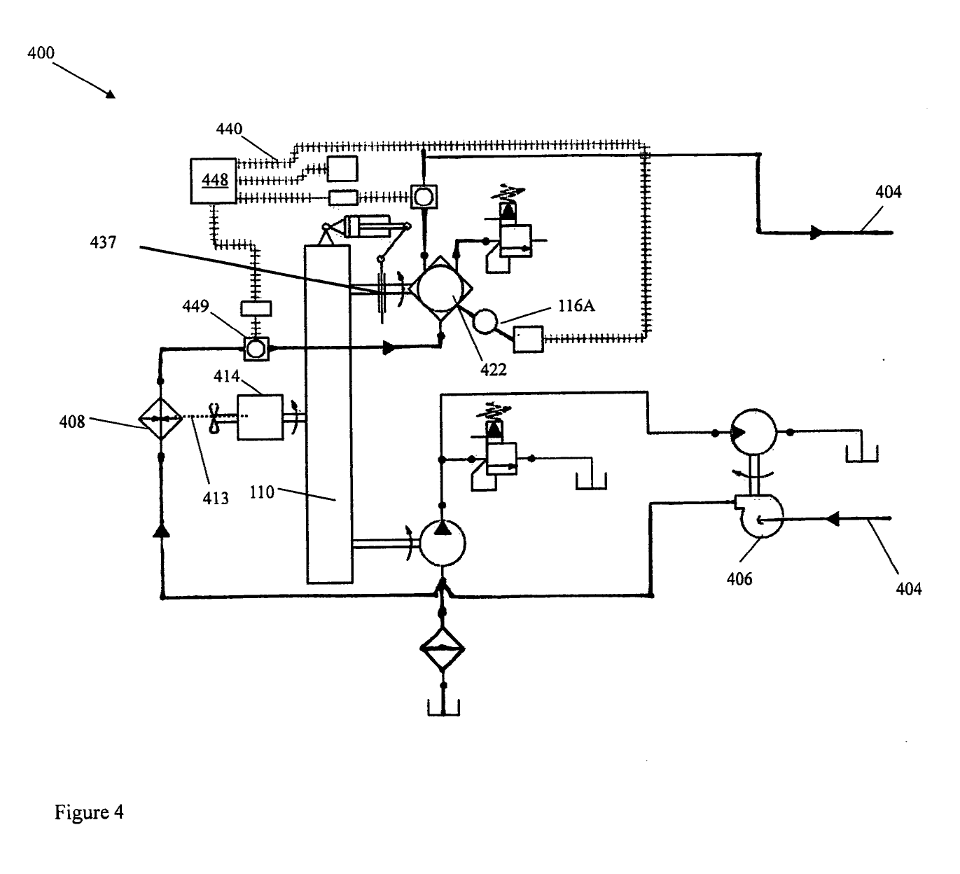

Referring now to FIG. 4, a process flow diagram of a flameless heating system 400 configured with a process control scheme 448 according to embodiments of the present disclosure, is shown. Although control scheme 448 may be described with respect to system 400, one of ordinary skill in the art would appreciate that control scheme 448 may be used with any of the systems, units, methods, etc. described herein.

Accordingly, the system 400 may include similar components, unit operations, and materials of construction as described for systems 100, 200, 300, etc., however, the systems are not necessarily identical. It may readily understood from FIG. 4 that conventional instrumentation for process measurement, control and safety may be usable with system 400. An operator interface or panel (515, FIG. 5B) may be configured to operate and monitor all of the functions of system 400, including operation of a dynamic heat generator 422.

The process control scheme 448 may further include, without any limitation, various sensors (e.g., temperature, pressure, flow, etc.) or other monitoring type devices, overpressure relief devices, regulators, and valves. Moreover, the process control for system 400 is not limited to any one particular scheme or configuration; instead, process control may be utilized any manner that would be understood to one of ordinary skill in the art.

Embodiments disclosed herein advantageously provide a modularized system that requires no electrical connections or electrical power. The modularization of a flameless heating unit may beneficially provide the ability for portability and/or usage in remote areas. The ability to provide heated fluids without the use of an open flame is highly advantageous for areas that are otherwise hazardous to open flames, such as oil and gas production sites. Embodiments disclosed herein are particularly beneficial for melting paraffin or other deposits formed in pipelines.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

What is claimed:

1. A method of cleaning pipelines, the method comprising:
pumping a process fluid through a flameless heating unit;
preheating the process fluid before it enters a dynamic heat generator operatively disposed in the flameless heating unit;
controlling the flameless heating unit to heat the process fluid to a temperature in a range sufficient to melt deposits formed in the pipeline; and
transferring the process fluid from the flameless heating unit into the pipeline.

2. The method of claim 1, the method further comprising the step of using the heated process fluid to operate a tool operatively deployed in the pipeline, whereby the heated process fluid and the tool work collectively to melt and clear at least a portion of the deposits.

3. The method of claim 2, wherein the deposits comprise one of wax, paraffins, asphaltenes, or combinations thereof.

4. The method of claim 2, wherein the tool comprises a pig.

5. The method of claim 4, wherein the pig is run into the pipeline by wireline operations.

6. The method of claim 5, wherein the flameless heating unit comprises:
an internal combustion engine;
a dynamic heat generator operatively connected to the internal combustion engine;
a pump configured to provide a discharged fluid to the dynamic heat generator; and
a first heater configured to cross exchange radiated heat produced by a combustion cycle of the internal combustion engine with the discharged fluid before the discharged fluid enters the dynamic heat generator.

7. The method of claim 6, the method further comprises increasing the pressure of the process fluid transferred to the pipeline with at least one booster pump.

8. The method of claim 7, wherein the at least one booster pump increases the pressure of the process fluid to a range of 200-300 bar.

9. The method of claim 8, the method further comprising using a second heater configured to cross exchange vapor heat produced by the combustion cycle of the internal combustion engine with a heated fluid stream produced by the dynamic heat generator.

10. A single skid modular flameless heating unit, the single skid unit comprising:
an internal combustion engine;
a dynamic heat generator operatively connected to the internal combustion engine;
a pump being responsive to the operation of the internal combustion engine, whereby the pump is configured to provide a discharged fluid to the dynamic heat generator;
a first heater configured to cross exchange heat produced by a combustion cycle of the internal combustion engine with the discharged fluid before the discharged fluid enters the dynamic heat generator; and
a second heater configured to cross exchange heat produced by the combustion cycle of the internal combustion engine with a heated fluid stream produced by the dynamic heat generator,
wherein a process outlet from the second heat is transferred into a pipeline in order to melt paraffin disposed in the pipeline.

11. The single skid unit of claim 10 further comprising a process control system for providing automation to the unit.

12. The single skid unit of claim 11 further comprising a control and monitoring system associated with the process control system.

13. A flameless heating process usable for treating fouled pipelines, the flameless heating process comprising:
receiving a process fluid into a modular flameless heating unit, the unit comprising:
an internal combustion engine;
a dynamic heat generator operatively connected to the internal combustion engine;
a pump configured to provide a discharged fluid to the dynamic heat generator; and
a first heater configured to cross exchange radiated heat produced by a combustion cycle of the internal combustion engine with the discharged fluid before the discharged fluid enters the dynamic heat generator;
preheating the process fluid with the modular flameless heating unit;
further heating the process fluid with the operation of the dynamic heat generator to a predetermined temperature;
outletting the process fluid from the single skid flameless heating unit to a desired location; and
using a second heater configured to cross exchange vapor heat produced by the combustion cycle of the internal combustion engine with a heated fluid stream produced by the dynamic heat generator.

14. The flameless heating process of claim 13, the process further comprising using the heated process fluid to operate a tool operatively disposed in the pipeline, whereby the heated process fluid and the tool work collectively to treat foulants deposited on the pipeline.

15. The flameless heating process of claim 14, wherein the foulants comprise one of wax, paraffins, asphaltenes, or combinations thereof.

16. The method of claim 15, wherein the tool comprises a pig run into the pipeline by wireline operations.

17. The flameless heating process of claim 16, wherein the pipeline comprises an aboveground pipeline.

18. The flameless heating process of claim 17, the process further comprises using a booster pump to increase an outlet process fluid stream of the second heater.
